(19) United States
(12) Patent Application Publication
(10) Pub. No.: US 2014/0017959 A1
(43) Pub. Date: Jan. 16, 2014

(54) ELECTRICAL CONNECTOR

(71) Applicant: ADVANCED-CONNECTEK INC., Taipei (TW)

(72) Inventors: Wei WAN, Taipei (TW); Shu-Lin Duan, Taipei (TW); Hua-Yan Wu, Taipei (TW); Xiao-Juan Qi, Taipei (TW)

(21) Appl. No.: 13/938,556

(22) Filed: Jul. 10, 2013

(30) Foreign Application Priority Data
Jul. 13, 2012 (CN) 201210242137.9

(51) Int. Cl. H01R 13/04

(52) U.S. Cl. CPC H01R 13/04
USPC 439/733.1

(57) ABSTRACT

An electrical connector includes a metal body and an insulation body received in the metal body and having therein first terminals and second terminals. Each first and second terminal has a connecting segment extending outward and a bent formed on a distal end of the connecting segment.

### CROSS-REFERENCES TO RELATED APPLICATIONS

This non-provisional application claims priority under 35 U.S.C. §119(a) on Patent Application No. 201210242137.9 filed in China, P.R.C. on 2012 Jul. 13, the entire contents of which are hereby incorporated by reference.

### BACKGROUND

1. Technical Field

The invention relates to an electrical connector and, more particularly, to an electrical connector having fewer components and more integrated elements to simplify the overall structure and lower the manufacture cost.

2. Related Art

Nowadays, as the advance of modern technology and the increasingly increased demands for high quality domestic electrical appliance, electrical devices for digital music and/or digital films are constantly improved to provide higher and higher quality to the listeners and/or viewers.

HDMI (high definition multimedia interface) is a kind of electrical connector aimed at providing high quality multimedia audio/video performance, which supports 1920×1080P HD digital signal as well as Dolby Digit/DTS digital audio format. In addition to the transmission of audio/video signals, HDMI can also transmit up to eight (8) different tracks of audio signals. As a result of all these advantages, a HDMI connector is now standard equipment equipped with audio/video devices.

The currently available components of the HDMI are all assembled individually, especially the terminals. When the HDMI connector is being made, the terminals are assembled in parallel and bent twice and then cut. The process for making terminals are complex and involves a lot of different assembly processes, which increases the manufacture cost and qualification thereof is not able to control.

### SUMMARY

The primary objective of the present invention is to provide an electrical connector which involves fewer components and less cost.

In order to accomplish the aforementioned objective, the electrical connector of the preferred embodiment of the present invention includes:

a metal body; and

an insulation body received in the metal body and having first terminals and second terminals respectively having a bent extending from a body thereof via a connecting segment.

In a preferred embodiment of the present invention, the metal body has a receptacle and the insulation body has an extension extending into the receptacle of the metal body.

In still another objective of the preferred embodiment of the present invention, each of the first terminals and the second terminals has a first contacts and second contacts crisscrossed arranged relative to the first contacts.

In still another objective of the preferred embodiment of the present invention, the electrical connector of the present invention further has a casing assembled together with the metal body and the insulation body.

Due to the integral formation of the terminals and characters thereof such as the bent, the first and second contacts and the connecting segment, each of the terminals is able to be made via molding and then is insert-molding onto the insulation body, which greatly reduces assembly process as well as manufacture cost.

### BRIEF DESCRIPTION OF THE DRAWINGS

FIG. 1 is an exploded perspective view of the electrical connector of the present invention;

FIG. 2 is an exploded perspective view of another electrical connector of the present invention;

FIG. 3 is an end view showing the assembled electrical connector of the present invention;

FIG. 4 is a perspective view showing the structure of the terminals;

FIG. 4A is an enlarged perspective view showing the structure of the distal end of each of the terminals;

FIG. 5 is a perspective view of the terminals of the present invention; and

FIG. 5A is an enlarged perspective view showing the terminals and a connecting segment of the present invention.

### DETAILED DESCRIPTION OF THE INVENTION

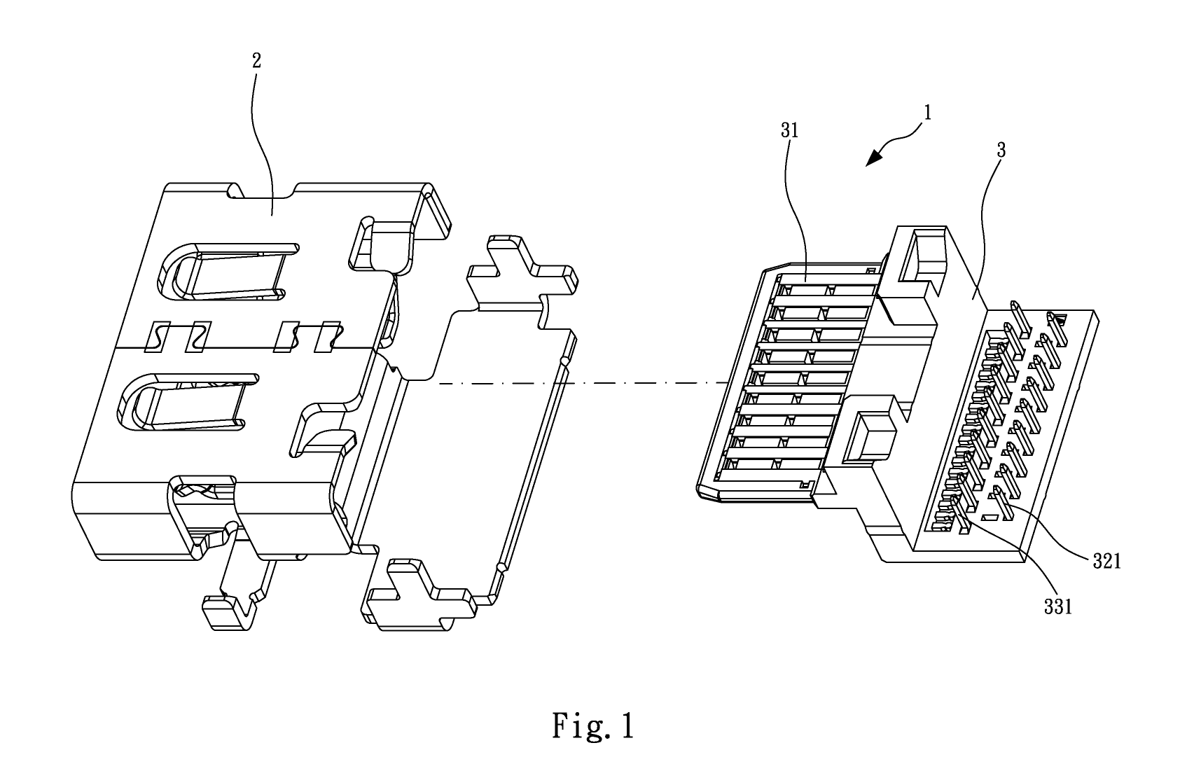

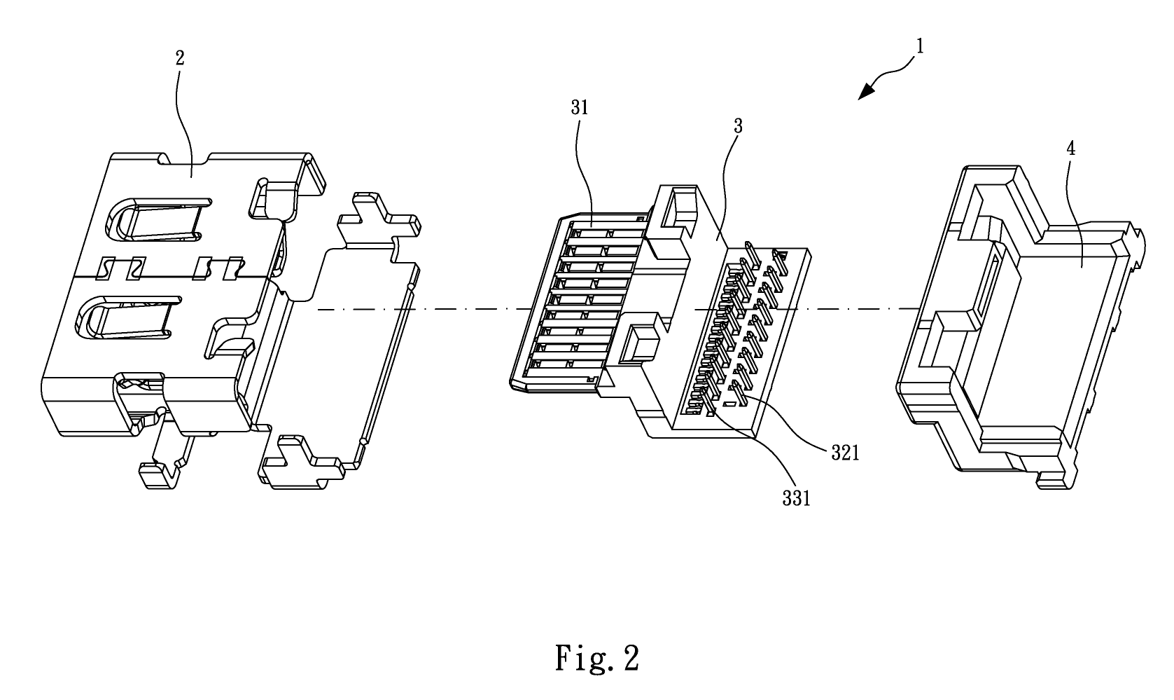

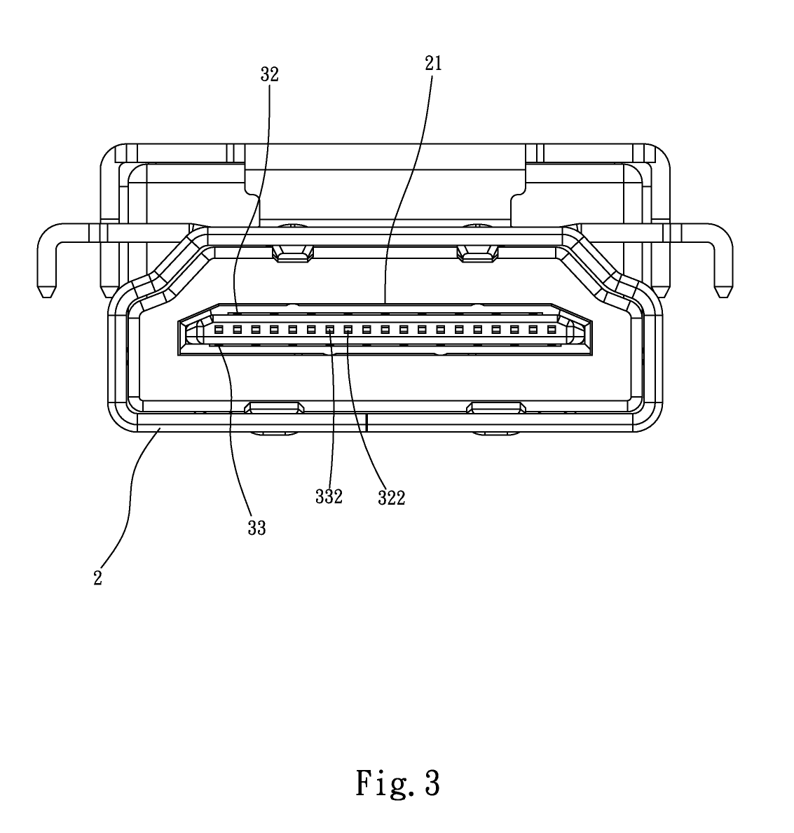

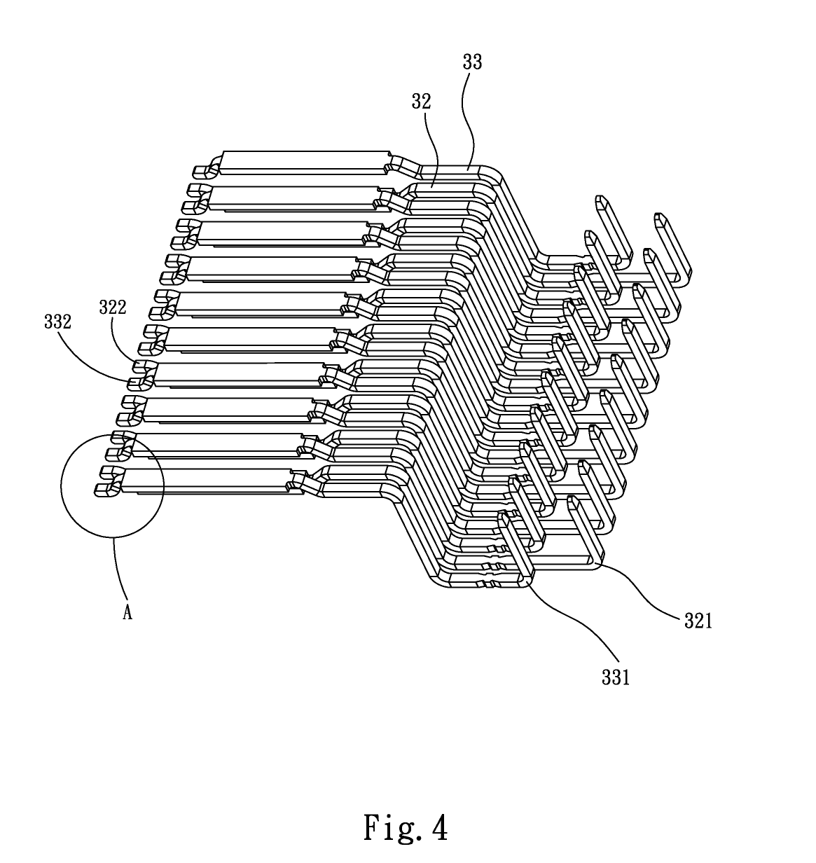

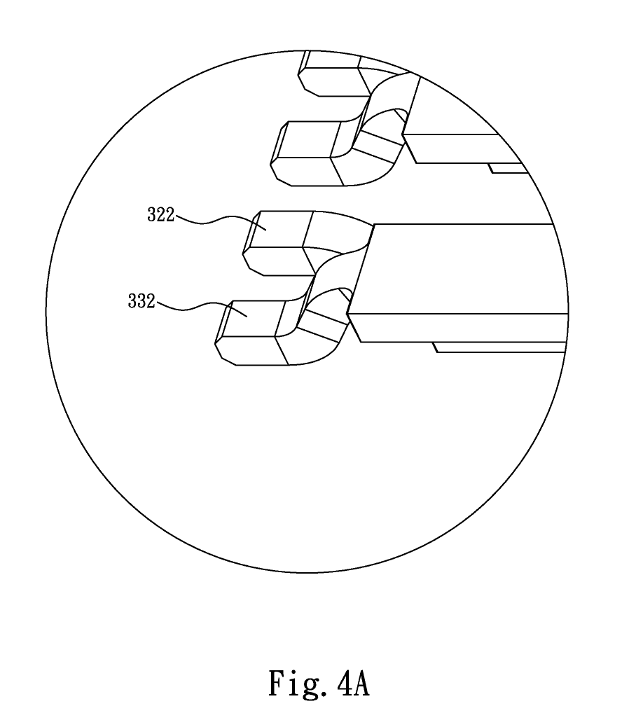

With reference to FIGS. 1, 2 and 3, the electrical connector 1 constructed in accordance with the preferred embodiment of the present invention is composed of a metal body 2 having a receptacle 21 formed inside the metal body 2 and an insulation body 3 having an extension 31 integrally formed with the body of the insulation body 3 to perfectly mate with the receptacle 21 of the metal body 2. The insulation body 3 further has first terminals 32 and second terminals 33 each having a bent 321, 331 respectively and integrally formed on a respective distal end thereof and extended from respective body via a connecting segment 34. First contacts 322 and second contacts 332 are formed on distal ends of the respective first terminal 32 and the respective second terminal 33 and the first contacts 322 are crisscrossed relative to the second contacts 332, and are formed oppositely to the bents 321, 331, as shown in FIG. 4 and FIG. 4A.

After the first terminals 32 with first contacts 322 formed on distal ends thereof and the second terminals 33 with second contacts 332 formed on distal ends thereof are formed, the first contacts 322 and the second contacts 332 are embedded in plastic to avoid deformation of the first contacts 322 as well as the second contacts 332.

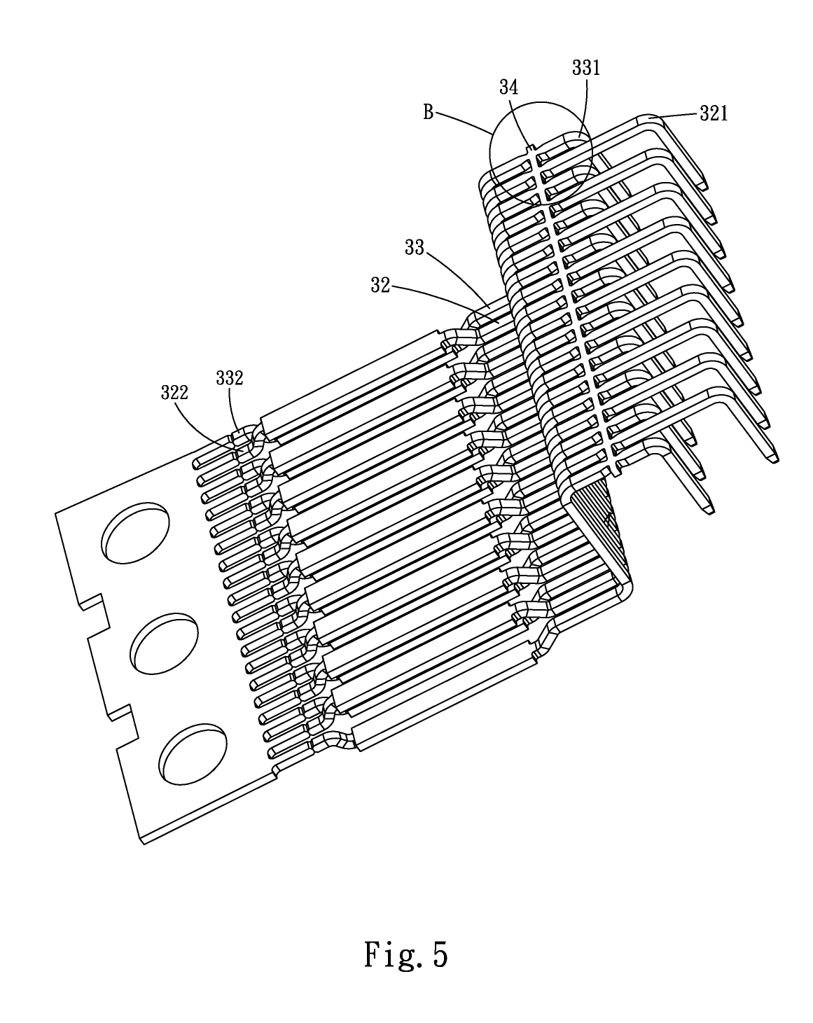

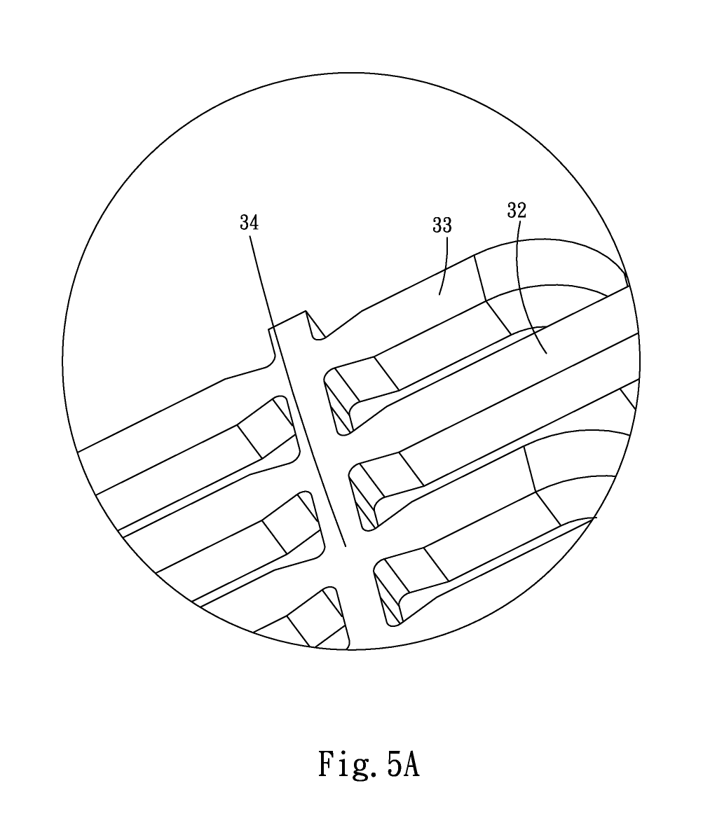

With reference to FIG. 5 and FIG. 5A, it is to be noted that when the electrical connector is being made, the formation of the first terminals 32 and the second terminals 33 are made by fixing the connecting segment 34 and then a molding process is adopted. After which, an insert molding is adopted to securely attach the first terminals 32 and the second terminals 33 onto the insulation body 3 to effectively reduce component as well as the manufacture cost. Here, the connecting segment 34 is substantially perpendicular to the first terminals 32 and the second terminals 33 so as to connect with the first terminals 32 and the second terminals 33; and, the connecting segment 34 is extruded out of the second terminals 33. That is to say, a first inclined angle defined between the first terminals 32 and the connecting segment 34 is about 90 degrees, for example, the first inclined angle is defined between 85 degrees to 95 degrees; a second inclined angle defined between the second terminals 33 and the connecting segment is about 90 degrees, for example, the second inclined angle is defined between 85 degrees to 95 degrees.

It is noted from the description that the structure of the present invention has the following advantages:

The first terminals 32 and the second terminals 33 are made via molding and then an insert molding is adopted to securely attach the first terminals 32 and the second terminals 33 on the insulation body to finish the process of semi-products, which greatly reduces the number of components.

When insert molding is being processed, the first contacts 322 and the second contacts 332 are buried in plastic to avoid unbalanced terminals.

A casing may also be added to the finished product and can be tailored to meet different requirements to enhance compatibility with others.

It is to be noted that although the preferred embodiment of the present invention has been described, other modifications, alterations or minor change to the structure should still be within the scope defined in the claims. As those skilled in the art will readily observe that numerous modifications and alterations of the device and method may be made while retaining the teachings of the invention.

What is claimed is:

1. An electrical connector comprising:
a metal body; and
an insulation body received in the metal body and having therein first terminals and second terminals aligned alternatively, the first terminals and the second terminals having a connecting segment extending outward and a bent formed on a distal end of the connecting segment, the connecting segment being substantially perpendicular to the first terminals and the second terminals so as to connect with the first terminals and the second terminals.

2. The electrical connector as claimed in claim 1, wherein the metal body has a receptacle.

3. The electrical connector as claimed in claim 2, wherein the insulation body has an extension to be received in the receptacle.

4. The electrical connector as claimed in claim 1, wherein each first terminal has first contacts and each second terminal has second contacts crisscrossed relative to the first contacts.

5. The electrical connector as claimed in claim 1 further having a casing to be assembled with the metal body and the insulation body.

6. The electrical connector as claimed in claim 1, wherein the first terminals are disposed between the second terminals, the connecting segment is extruded out of the second terminals.

7. The electrical connector as claimed in claim 1, wherein the electrical connector is a HDMI electrical connector.
